(19) United States
(12) Patent Application Publication
(10) Pub. No.: US 2015/0379811 A1
(43) Pub. Date: Dec. 31, 2015

(54) PRESENTING WAGERING GAMES USING A WAGERING GAME APPLICATION PROGRAMMING INTERFACE

(71) Applicant: WMS Gaming, Inc., Waukegan, IL (US)

(72) Inventors: Edward Q. Earley, Chicago, IL (US); John P. Neumann, Oswego, IL (US); Michael G. Tyranski, Chicago, IL (US)

(21) Appl. No.: 14/315,062

(22) Filed: Jun. 25, 2014

(51) Int. Cl. G07F 17/32

(52) U.S. Cl. CPC G07F 17/3225; G07F 17/3244

(57) ABSTRACT

Some embodiments include a method for presenting wagering games in a browser on a mobile device. The method can include detecting, in an application programming interface (API) on the mobile device, a request to initiate a wagering game in the browser on the mobile device. The method can also include after detecting the request, receiving one or more API calls from a wagering game module residing on the mobile device, wherein the API calls request wagering-game-specific services to facilitate progress of the wagering game. The method can also include transmitting, by the API to the browser, information needed by the wagering game module to present the wagering game in the browser.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2014, WMS Gaming, Inc.

### FIELD

Embodiments of the inventive subject matter relate generally to wagering game systems, and more particularly to wagering game systems including an application programming interface for presenting content on gaming devices.

### BACKGROUND

Wager gaming, such as casino-based gaming on slot machines, has been a cornerstone of the gaming industry for several years. More recently, web-based wager gaming has become popular. For both web-based gaming and casino-style machines, the popularity of games depends on the likelihood (or perceived likelihood) of winning money and the intrinsic entertainment value of the games relative to other available gaming options. Where there are competing gaming options for which there are similar expectations of winning, players are likely to play the most entertaining and exciting games. Shrewd operators consequently strive to develop the most entertaining and exciting games, features, and enhancements to attract frequent play, and hence increase profitability to gaming operators. Therefore, there is a continuing need for wagering game providers to continuously develop new games and gaming enhancements that will attract frequent play.

### BRIEF DESCRIPTION OF THE FIGURES

Embodiments of the invention are illustrated in the Figures of the accompanying drawings in which:

FIG. 1 is a block diagram illustrating components and operations for creating a consistent gaming experience using wagering games from different providers, according to some embodiments of the inventive subject matter.

FIG. 2 is a block diagram illustrating an example configuration for a computing device, according to some embodiments of the invention.

FIG. 3 is a block diagram illustrating a wagering game server, according to some embodiments of the inventive subject matter.

FIG. 4 is a sequence diagram showing communications and operations for using an API to present wagering games in a browser, according to some embodiments of the invention.

FIG. 5 is a sequence diagrams showing communications and operations, according to some embodiments of the invention. Some wagering games may have a bonus round.

FIG. 6 is a sequence diagram showing more stages of operation.

FIG. 7 is a flow diagram illustrating operations for configuring a wagering game device to present wagering games, according to some embodiments of the inventive subject matter.

FIG. 8 is a flow diagram illustrating operations for a meta-game, according to some embodiments of the inventive subject matter

FIG. 9 is a block diagram illustrating a wagering game network 700, according to example embodiments of the invention.

### DESCRIPTION OF THE EMBODIMENTS

### Introduction

This section provides an introduction to some embodiments of the invention.

Players are often loyal to particular games and game makers. Some players consistently return to a particular game because they are comfortable and familiar with the game's overall experience. Over time, players may develop an understanding about a game's graphics, sounds, animations, features, etc. Such an understanding leads the player to being comfortable with the game. After establishing a comfort level with certain games, players may resist trying new and unfamiliar games. Some embodiments of the inventive subject matter enable computing devices (e.g., smartphones, tablets, etc.) to present games from different gaming providers, while maintaining a consistent gaming experience. For example, a tablet computer may present video card games from Game Company X, and slots games from Game Company Y. The tablet computer can use similar graphics and sound to present both the card games and slots games. Additionally, there may be consistent branding and other features despite having different game providers. As a result, some embodiments enable players to play a greater variety of games, while having a consistent and familiar gaming experience.

Some embodiments provide such a common gaming experience in the form of a social casino. The social casino can facilitate social networking between players (chat, player pages, social contact lists, etc.), and offer a platform for playing wagering games. The social casino can offer meta-games by tracking game play, and offering various awards based on the game play. For example, one meta-game may unlock new games for players who achieve certain game results (e.g., slots reel combination). Another meta-game may offer a new game episode for players who have played a number of different games for a given time duration.

To facilitate the functionality described above, some embodiments utilize a computing device (e.g., tablet computer) that includes a browser, code for one or more games, and an application programing interface (API). Initially, a player may browse to a website (e.g., the social casino website) that serves web pages for configuring the browser to play games (i.e., webpages that facilitate acquisition of the wagering game code, API, and any other necessary content).

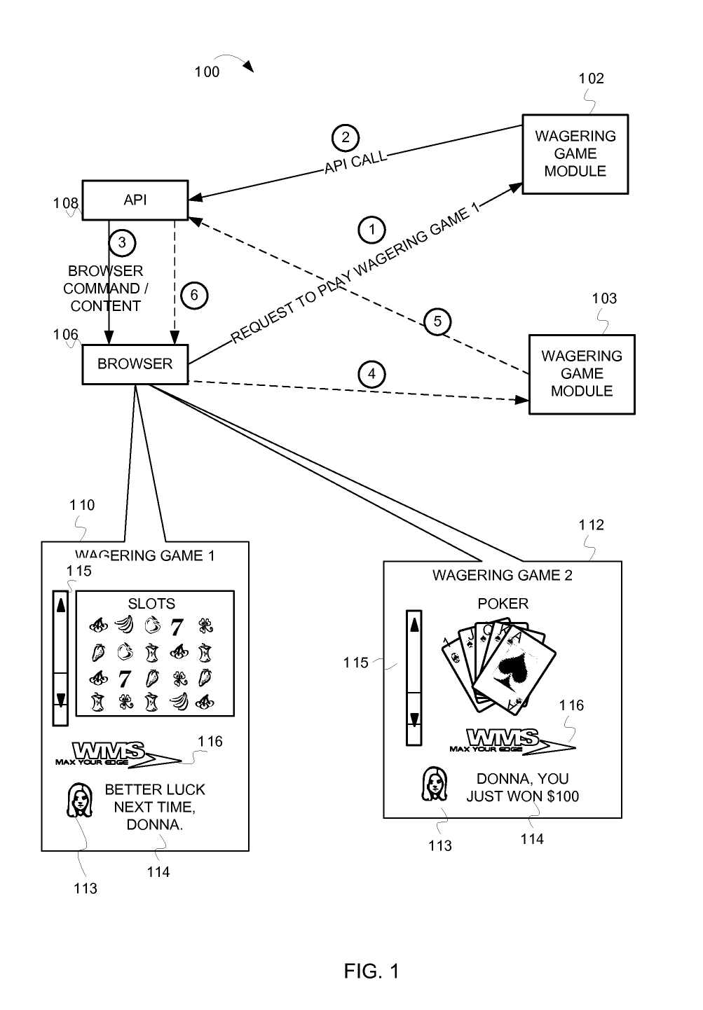

After the initial configuration, players use the browser to play games originating from one or more game makers. In some embodiments, the wagering game code controls games (e.g., determines game results), and uses the API to present graphics and audio in the browser. Some embodiments of the wagering game code do not communicate directly with the browser. Instead, they communicate with the API residing on the player's computing device. The API can receive program calls and parameters (e.g., game results) from the wagering game. The API can specify gaming content for presentation by the browser. The browser can present the content using graphics, audio, animations, etc. that create a particular gaming experience. Embodiments of the API allow the browser to present gaming content from any wagering game capable of calling the API. The discussion of FIG. 1 further explains some embodiments of the inventive subject matter.

FIG. 1 is a block diagram illustrating components and operations for creating a consistent gaming experience using wagering games from different providers, according to some embodiments of the inventive subject matter. FIG. 1 shows a system 100 including wagering game modules 102, 103, a browser 106, and a wagering game API 108. In some embodiments, all the components reside on a single computing device, such as a tablet computer, mobile phone, etc. In other embodiments, the wagering game resides on a remote device, such as a wagering game server.

In FIG. 1, the wagering game modules 102, 103 may originate from different wagering game makers. For example, the wagering game 102 may have been made by Williams Interactive™ of Chicago, Illinois, whereas the wagering game modules 103 may be made by a different game maker. Each wagering game module can offer a different wagering game, such as slots, black jack, poker, etc.

The system 100 can also include a meta-game module (not shown) for conducting meta-games. Meta-games can award prizes for game play and results related to the wagering games controlled by the wagering game modules 102, 103. For example, the meta-game module can unlock various content (games, episodes, etc.) based on play duration, game results, money spent, etc.

During operation (see stage 1), a player can direct the computing device's browser 106 to request a first wagering game controlled by the wagering game module 102. In turn (see stage 2), the browser 106 transmits a gameplay request to the wagering game module 102. The wagering game module 102 responds to the gameplay request by calling the API 108 to initiate a wagering game in the browser 106. In response to the API call, the API 108 executes program code associated with the call. The API program code transmits parameters, data, content, and other information to the browser 106, and the browser 106 presents content representing wagering game.

In some embodiments, the API 108 acts as an “adapter” enabling any wagering game module capable of calling the API 108 to present wagering games in the browser 106. Furthermore, in some embodiments, the API 108 assumes responsibility for formatting information to be compatible with the browser 106. Therefore, in some embodiments, the wagering game modules 102, 103 need not contain components capable of formatting content for presentation on the browser 106. In FIG. 1, the dotted arrows show gameplay requests and API calls between the browser 106, wagering game module 103, and API 108. These operations are similar to those at stages 1-3.

Although the browser 106 presents games created by different game makers, embodiments provide players with a consistent gaming experience on the computing device 104. The game window 110 shows a game controlled by wagering game module 102, whereas the game window 112 shows a game controlled by wagering game module 103. Although each game was made by a different game maker, both game windows include similar controls 115, avatars 113, messaging 114, and branding 116. As a result, irrespective of which wagering game module controls the wagering games, players have a consistent game experience.

Although FIG. 1 describes some embodiments, the following sections describe many other features and embodiments. The following discussion describes example configurations of a computing device and wagering game server, respectively.

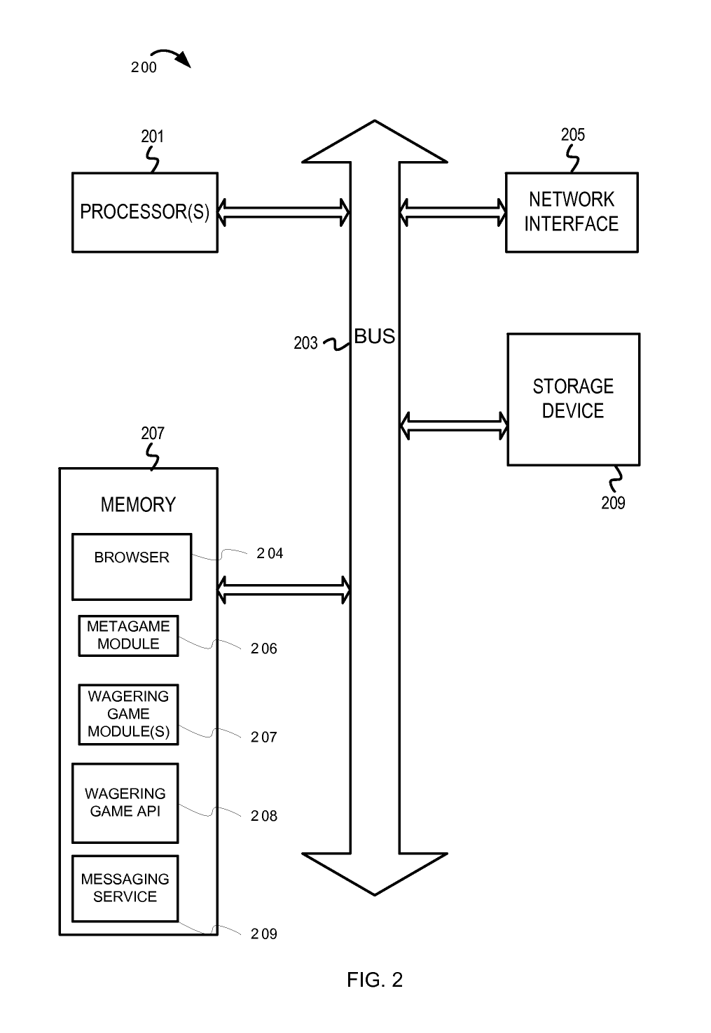

FIG. 2 is a block diagram illustrating an example configuration for a computing device, according to some embodiments of the invention. In FIG. 2, a computing device 200 includes a processor unit 201 (possibly including multiple processors, multiple cores, multiple nodes, and implementing multi-threading, etc.). The computer device also includes memory 207. The memory 207 may be system memory, such as one or more of cache, SRAM, DRAM, zero capacitor RAM, Twin Transistor RAM, eDRAM, EDO RAM, DDR RAM, EEPROM, NRAM, RRAM, SONOS, PRAM, etc.

The computer system also includes a bus 203 (e.g., PCI, ISA, PCI-Express, HyperTransport®, InfiniBand®, NuBus, etc.), a network interface 205 (e.g., an ATM interface, an Ethernet interface, a Frame Relay interface, SONET interface, wireless interface, etc.), and a storage device(s) 209 (e.g., optical storage, magnetic storage, etc.).

The system memory 207 includes components to implement embodiments described above. For example, the system memory 207 includes a browser 204, meta-game module 206, and API 208. The browser 204 can fetch and present information stored locally, and information received over a network (e.g., World Wide Web). In some embodiments, the browser 204 can include any suitable off-the-shelf browser (e.g., Google's Chrome browser, Microsoft's Internet Explorer, etc.). Such an off-the-shelf browser may be augmented with various components to achieve the functionality described herein. For example, the browser 204 can include a programming language interpreter, such as a Javascipt interpreter, Java® interpreter, etc. In some instances, the browser 204 includes a meta-game module 206. The meta-game module 206 can include any suitable code (e.g., Java® code) configured to conduct meta-games based on results of games controlled by The meta-game module 206 may use locally stored graphics, animations, audio, etc. to present the wagering games in the browser 204.

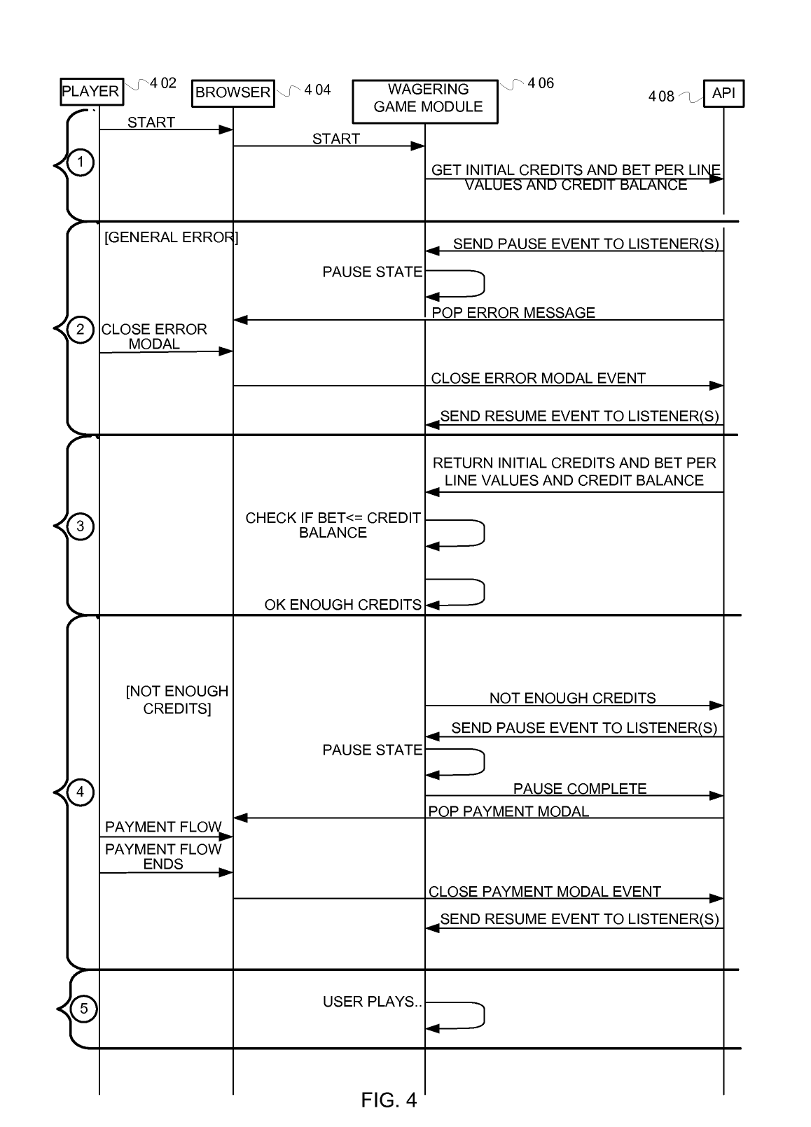

The wagering game API 208 can include program code for processing calls from the wagering game module(s) 207. Various components can call the API 208 to provide a set of functionality including wagering-game-specific services (e.g., see discussion of FIGS. 4-6). For example, a wagering game module 207 can call the API 208 to present information in the browser 204, determine credit information for wagering games, unlock new games, and more. When calling the API, a wagering game server (or other device) can transmit a request (aka “a call”) in a format supported by the API 208. The format can include keywords and parameters arranged in a format understandable by the API 208. The key words can trigger particular functionality (e.g., program code), and the parameters can provide data needed by such functionality. For example, as part of initiating a wagering game, a wagering game module may call the API 208 to determine credit information for the game. Such a call may be in any suitable format understood by the API 208. For example, the call may have the following form: CreditInfo(PlayerID,SessionID). In the example call noted above, “CreditInfo” is a keyword, and “PlayerID” and “SessionID” are parameters identifying a player and gaming session for which the credit information is needed. The API 208 can define calls in any suitable format, and calls can be made and serviced using any suitable programming construct (e.g., any suitable programming language code).

In responding to calls, embodiments of the API 208 execute functionality corresponding to the calls (e.g., the keywords). For some calls, the API communicates with remote devices (e.g., account servers, advertising servers, wagering game machines, social networking servers, etc.) to determine results for the call. For other calls, the API 208 may use only local functionality. For some calls, the API 208 can return information to the caller, or otherwise provide information to the caller and other devices (e.g., the web browser 204). Referring back to the example call from above, the API 208 can execute functionality associated with the “CreditInfo” call, and provide credit information back to the wagering game module 207.

According to some embodiments, wagering game modules can utilize the API 208 to facilitate presentation of wagering games. For example, a player may want to play wagering games in the web browser 204 on the computing device 200 (e.g., a tablet computer). Because the computing device 200 includes the API 208, a wagering game module 207 can utilize the API 208 and to present content (e.g., game results, etc.) on the browser 204. The wagering game module 207 need not be equipped with logic for formatting content for presentation on the browser 204. Instead, the wagering game module 207 can utilize the API 208 to facilitate presentation of content by the browser 204. In some embodiments, the API 208 can service calls from a plurality of wagering game modules, while providing content to the tablet's browser in a consistent format. That is, regardless of which wagering game module calls the API 208, the API 208 causes the browser to present content in a particular format. Such a consistent format enables the browser to present a consistent gaming experience, even if the browser is presenting content in response to different wagering game modules.

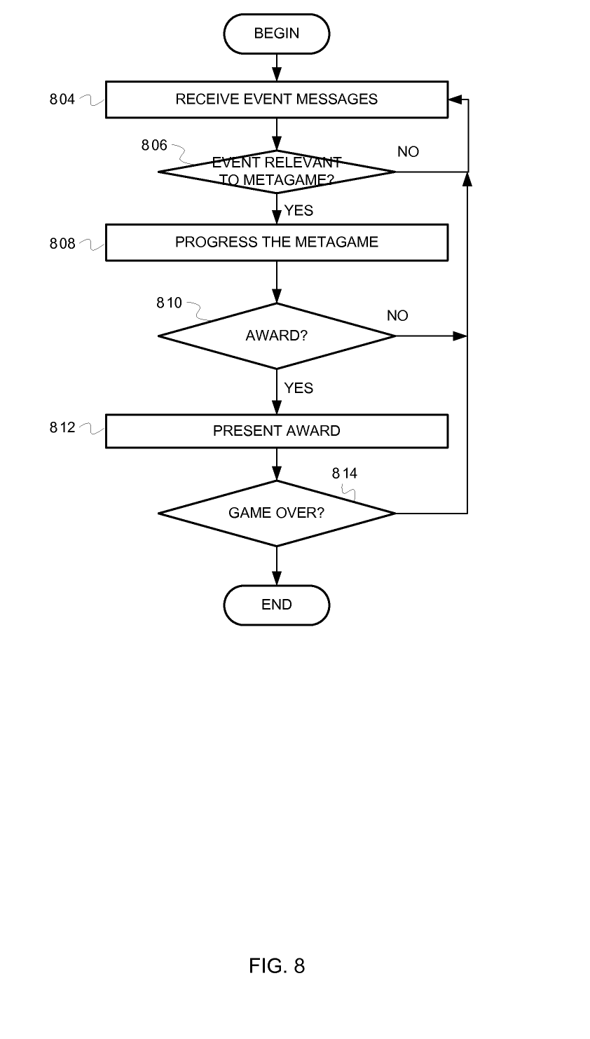

The memory 207 also includes a messaging service 209 that receives and publishes event messages indicating operations and events occurring in the computing device 200. The events can be game results, timer events indicating durations of game play or other operations, coin-in events, win award events, or any other suitable events. In some embodiments, the meta-game module conducts meta-games based on events occurring in the computing device 200. For example, the meta-game module may conduct a meta-game in which game pieces progress based on winning/losing events in wagering games (see discussion of FIG. 8 below). In some embodiments, upon conclusion of wagering games, the meta-game module causes presentation of content for a consistent gaming experience. For example, after each of a plurality of different games concludes, the meta-game module may present similar post-game information for each game (e.g., using the same graphics and audio making a consistent gaming experience). In some instances, the meta-game module does not conduct meta-games, but only performs operations for controlling game selection, post-game celebration, and other operations that do not involve the wagering game modules. As such, some embodiments may refer to the meta-game module as a “control module”.

Some embodiments may include fewer or additional components not illustrated in FIG. 2 (e.g., video cards, audio cards, additional network interfaces, peripheral devices, etc.). The processor unit 201, the storage device(s) 209, and the network interface 205 are coupled to the bus 203. Although illustrated as being coupled to the bus 203, the memory 207 may be coupled to the processor unit 201. The computing device 200 can also include various peripherals for facilitating wagering game play, such as devices for swiping credit cards, reading ticket vouchers, joysticks, keyboards, and any other suitable input/output devices.

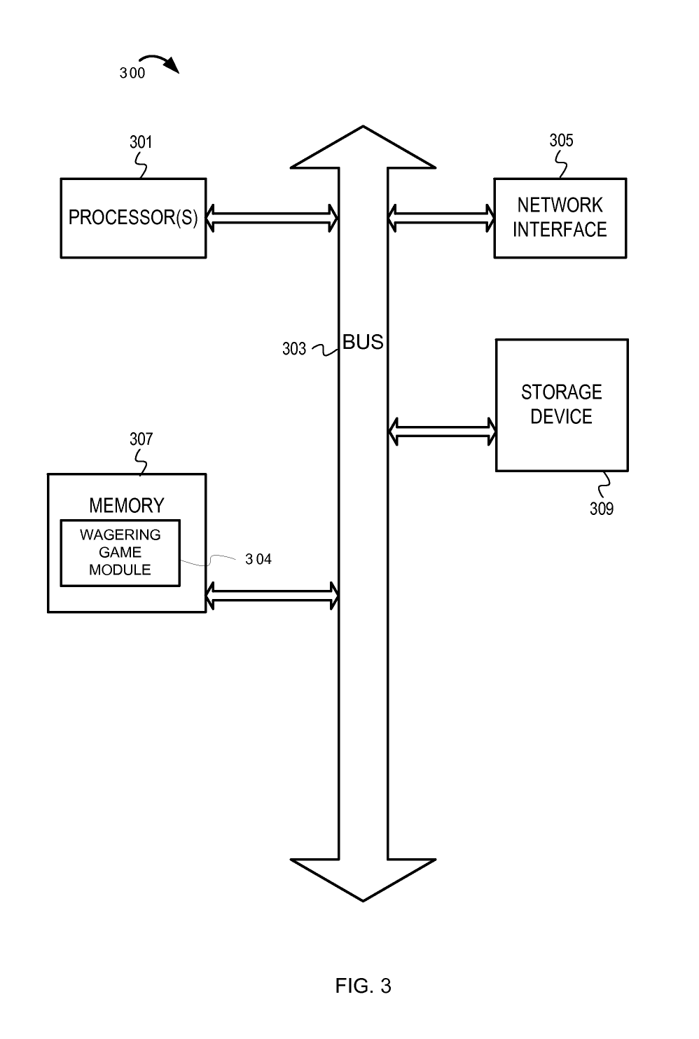

As noted above, the computing device can communicate with remote devices, such as wagering game servers. FIG. 3 shows an example wagering game sever.

FIG. 3 is a block diagram illustrating a wagering game server, according to some embodiments of the inventive subject matter. In FIG. 3, a wagering game server 300 includes a processor unit 301 (possibly including multiple processors, multiple cores, multiple nodes, and implementing multi-threading, etc.). The computer device also includes memory 307. The memory 307 may be system memory, such as one or more of cache, SRAM, DRAM, zero capacitor RAM, Twin Transistor RAM, eDRAM, EDO RAM, DDR RAM, EEPROM, NRAM, RRAM, SONOS, PRAM, etc.

The computer system also includes a bus 303 (e.g., PCI, ISA, PCI-Express, HyperTransport®, InfiniBand®, NuBus, etc.), a network interface 305 (e.g., an ATM interface, an Ethernet interface, a Frame Relay interface, SONET interface, wireless interface, etc.), and a storage device(s) 309 (e.g., optical storage, magnetic storage, etc.).

The system memory 307 includes components to implement embodiments described above. For example, the system memory 307 includes a wagering game module 304 that can determine results for wagering games, such as slots, keno, blackjack, poker, baccarat, etc. The wagering game unit 304 can provide wagering game content (e.g., wagering game results, graphics, audio, video, etc.) to any number of remote devices. For example, the wagering game module 304 can provide results to wagering game machines and computing devices residing at disparate locations (e.g., casinos in Las Vegas, Nev. and Atlantic City, N.J.). In some embodiments, the wagering game unit 304 makes calls to remote APIs, as part of a process for presenting wagering games on remote devices. Some embodiments of the wagering game server perform operations described below (e.g., see FIGS. 4-6).

Although not shown, the wagering game server 300 can include components for producing and transmitting web pages to remote web clients. For example, the system memory 307 can include a web server that provides web pages to remote devices.

Any component described herein can include hardware, firmware, and any computer readable media including instructions (e.g., program code) for performing the operations described herein. Any combination of one or more computer-readable medium(s) may be utilized. The computer-readable medium may be a computer-readable signal medium or a computer-readable storage medium. Some examples (a non-exhaustive list) of the computer-readable storage medium include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer-readable storage medium may be any tangible medium that can store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

### Example Communications and Operations

This discussion continues with a description of several operational flows for utilizing an API to present wagering games in a browser. In the discussion below, sequence diagrams describe communications between a browser, API, and wagering game module. In some embodiments, the API, browser, and wagering game module reside on a computing device (e.g., see FIG. 2). In other embodiments, the wagering game module can reside on a separate device, such as a wagering game server (e.g., see FIG. 3). In yet other embodiments, different devices can perform the operations and communications descried herein.

FIGS. 4-6 show example scenarios of how some embodiments operate. Although the operations and communications proceed in stages (in FIGS. 4-6), some embodiments may perform the stages in a different order. Furthermore, some operations and communications are optional, as some scenarios of operation do not require all operations shown in the drawings.

FIG. 4 is a sequence diagram showing communications and operations for using an wagering game API to present wagering games in a browser, according to some embodiments of the invention. FIG. 4 shows a player 402, browser 404, wagering game module 406, and API 408. For sake of illustration, the browser 404, API 408, and wagering game module 406 are shown separately. However, in various implementations, these components can integrated to different degrees, and they can reside on a computing device, such as a tablet computer, mobile phone, or notebook computer. The player 402 represents an entity (e.g., a wagering game player) providing input to the browser 404.

In FIG. 4, the sequence diagram shows five stages of operations and communications. During stage 1, the player 402 initiates a wagering game in the browser 404. For example, the player 402 may actuate a “game start” button shown in the browser 404. In response to the wagering game initiation, the browser 404 transmits a game start request to the wagering game module 406. In turn, the wagering game module 406 requests the game's initial betting and credit information by calling the API 408. For example, the module 406 may request the game's initial betting denominations, and bet per line values. The API 408 may not store such information, so it may request the credit information from a remote service, such as a player account server (not shown).

In the sequence diagram 400, stage 2 shows how the components handle a general error. The discussion about error handling will postponed until later (see discussion of stage 2 below).

At stage 3, the API 408 responds to the wagering game module's request for credit information by sending a message including the credit information (e.g., initial bet denominations, credits per bet line, etc.). As noted, the API 408 may have received this information from a remote service. The wagering game module 406 verifies that the player has enough credits to play by checking whether the player's credit balance will cover any initial bet. If the credit balance will not cover the initial bet, the system proceeds to stage 4. If credit balance is sufficient to cover the initial bet, the system proceeds to stage 5.

During stage 4, the wagering game module 406 transmits to the API 408 a message indicating there are not enough credits to cover the initial bet. The API 408 responds by transmitting a “pause” event back to the wagering game module 406. The wagering game module 406 remains in a “pause” state until the credit issue is resolved. Because there are not enough credits, the API 406 instructs the browser 404 to present content for acquiring or credits from the player 402 (see “pop payment” message). Although not shown, the browser 404 may communicate with other devices (e.g., a remote bank website, a player account website, etc.) to acquire enough credits to play the game. In turn, the browser 404 transmits to the API 408 a message indicating the payment event has concluded. At this point, there are enough credits to play the wagering game. Next, the API 408 transmits to the wagering game module 406 a message to resume the wagering game (i.e., the message prompts the module 406 to move out of the “pause” state).

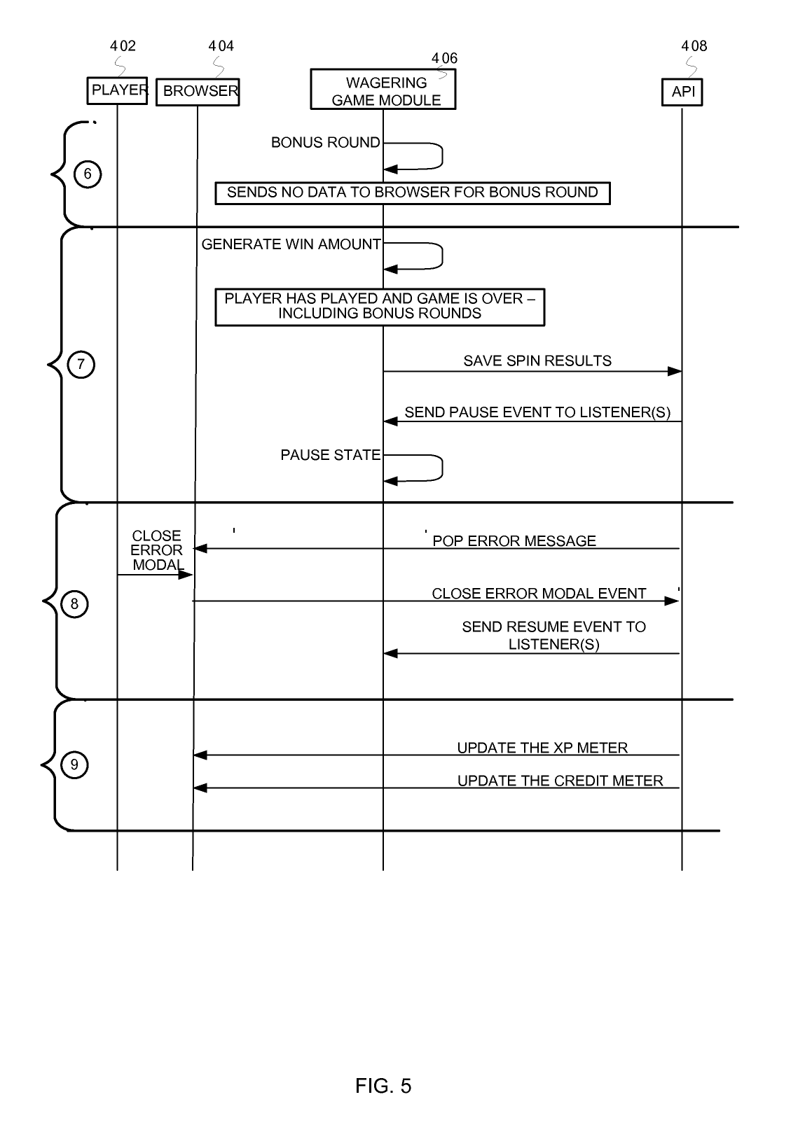

At stage 5, the player plays the wagering game. For a slots game, the module 406 presents spinning reels, and the results. The stages continue in FIG. 5.

FIG. 5 is a sequence diagrams showing communications and operations, according to some embodiments of the invention. Some wagering games may have a bonus round. In FIG. 5, stage 6 shows how some embodiments of the wagering game module 406 may execute code that presents the bonus game in the browser, without any information from other components. The bonus game may be funded by the base game, or from an independent funding source.

After the player has played the base game and any bonus game, the system updates credit meters and performs other tasks, as shown in stages 7-9. In stage 7, if player has won the game, the module 406 generates a win amount. Next, the module 406 calls the API 408 to save results of the game. In response, the API sends a “pause” event to the module 406, causing the module 406 to remain in a paused state. If errors occur, stage 8 shows error handling operations (described later). During stage 9, the API 408 instructs the browser 404 to update credit meters. In some embodiments, this communication prompts the browser 404 to update data structures tracking credits on the credit meters, and credit meter graphics in the browser's user interface.

After the player 402 has achieved a result of the wagering game, the result (or other factors) may cause the game to “level-up”, and new content may be unlocked. Stages 10-12 show operations and communications associated with these events.

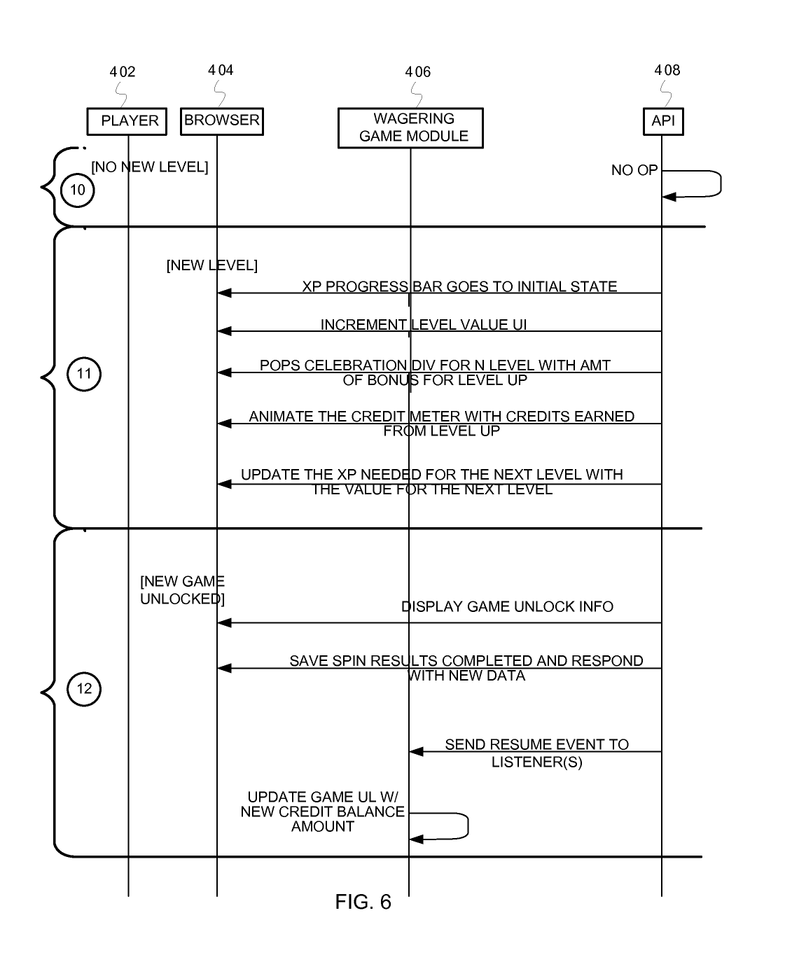

FIG. 6 is a sequence diagram showing stages 10-12. During stage 10, if the wagering game result does not cause the game to level-up, the components do not perform additional operations or communications. In some embodiments, other factors (e.g., coin in, maximum bets, etc.) can affect whether the game levels-up. Stage 11 shows operations communications performed when a new level is available.

During stage 11, the API 408 transmits a series of messages to the browser 404. Among the messages, the API 408 transmits content that instructs the browser to increment a “level-up” indicator in the user interface (e.g., on the gaming webpage). Additionally, the API 408 instructs the browser to present celebrations for the level-up, where the celebrations include graphics for the level-up. The API 408 also transmit content that instructs the browser to present animations that update the credit meter amounts earned from the level-up. As part of unlocking the new level, the API 408 initializes a play time progress bar in the browser 404. That is, the API 408 resets a graphical bar indicating how much time a player has been playing the game (referred to as XP progress bar in FIG. 4). The API 408 also causes the browser 404 to update a graphical indicator showing the time needed for the next level up.

Stage 12 shows operations and communications for unlocking a new game. In some instances, results from the wagering game may cause the system to unlock a completely new wagering game (e.g., a different wagering game). During stage 12, the API 408 transmits content that instructs the browser 404 to display information related to unlocking the new game, such as a passcode for unlocking the new game. Alternatively, the API's message may automatically unlock new content, and the browser 404 may display information about the new game. The API 408 also transmits a message instructing the browser 404 to that the game results have been saved, and the API 408 transmits a resume event to the wagering game module 406 and any other listeners. Additionally, the wagering game module 406 updates the new game with a new credit balance amount.

As discussed above, the system may encounter general errors. Stage 2 shows operations communications for handling such errors. Upon encountering a general error, the API 408 publishes (e.g., via the messaging service described herein) a pause event to listeners including the wagering game module 406. In response, the wagering game module 406 enters a paused state. Next, the API 408 transmits content instructing the browser 402 to present an error message in the user interface. In response to presenting the error message, the browser 402 may receive input from the player 400. The player input may (explicitly or implicitly) instruct the browser 402 to terminate the error handling sequence. In turn, the browser 402 transmits to the API 408 a request to terminate the error event. In response to the request to close the error event, the API 408 transmits a “resume event” message to the module 406, causing the server to resume operation.

This discussion continues with a description of operations for configuring a computing device (e.g. tablet computer, mobile phone, etc.) to present wagering games in a browser. After the computing device is configured to include all necessary components, it can present wagering games (including meta-games).

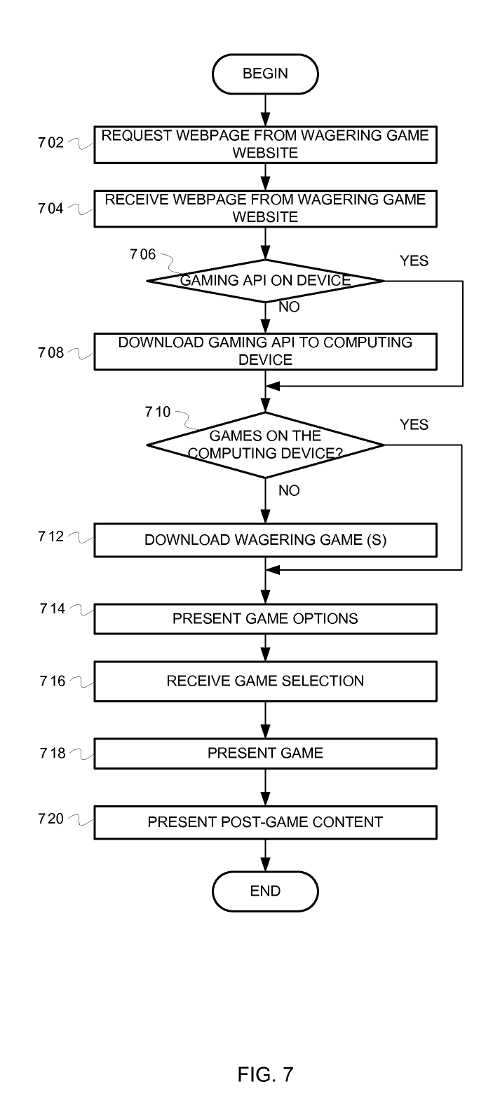

FIG. 7 is a flow diagram illustrating operations for configuring a wagering game device to present wagering games, according to some embodiments of the inventive subject matter. The operations of FIG. 7 can be performed by the computing device, the browser, and components received over a network. The components can include program code executable by the browser. Such code can cause the browser to perform various operations described herein. In some embodiments, the browser can natively execute the code. In other embodiments, the browser may include extensions, plug-ins, or other components that facilitate code execution. In some embodiments, the code includes one or more wagering game modules, the wagering game API, and other components.

The flow 700 begins at block 702, where a browser requests a webpage for wagering game website. At block 704, the browser receives the webpage from the wagering game website. In some embodiments, the webpage includes code for determining whether the computing device includes a wagering game API that facilitates wagering games in the browser. The flow continues at block 706.

At block 706, code in the webpage (or code accessed via a link in a webpage) determines whether the wagering game API is available on the computing device. If the API is not available, the flow continues at block 708. Otherwise, the flow continues at block 710.

At block 708, the computing device downloads the wagering game API. This and other operations in this flow can be performed under control of code in the webpage, code accessible by a link in the web page, code downloaded to the browser from a website, etc. In some embodiments, the browser executes the code regardless of its source. After downloading the API, the flow continues at block 710.

At block 710, code in the webpage (or otherwise available from accessing webpage) determines whether games have been downloaded to the computing device. If not, the code downloads one or more wagering game modules to the computing device. The code may also download a meta-game module. In some embodiments, the modules include code executable on the browser. In some embodiments the modules can be browser extensions or plug-ins configured to operate via the browser, and present content in the browser. If modules have already been downloaded to the browser, the flow continues at block 714.

At this point, the gaming device, which includes a browser, has been configured with the wagering game API, wagering game modules, and meta-game module. At block 714, the browser presents game options. Some embodiments include code for controlling presentation of game options and other content. For example, the meta-game module may control presentation of game options. The flow continues at block 716.

At block 716, a game selection is received. The meta-game (or other control code) receives the game selection, and passes control to the wagering game module responsible for controlling the selected wagering game. At block 718, a wagering game module presents the wagering game. At block 720, the meta-game module (or other code, as noted above) presents post-game content, such as celebrations, information, etc. The post-game content can include information about the wagering game, such as credits won/lost, time playing game, total bets made, total bets won, total bets lost, etc. The post-game content can include the same graphics and sound for wagering games from different game manufacturers, so players have a common gaming experience across games (e.g. a social casino provides a common gaming experience for all games). After block 720, the flow ends.

As noted above, some embodiments offer a meta-game. The meta-game can use results from other games to cause progress of the meta-game. For example, if a player plays a particular game for a given time duration, the meta-game can unlock new content for the particular game. As another example, the player achieves a given result in a slots game, the result may cause movement of game pieces in the meta-game. Events that may be relevant to meta-games can include events arising from wagering games (e.g., a combination of slot reels), events arising from interactions with the browser (e.g., use of particular buttons), events arising from interactions with certain websites (e.g., use particular URLs), etc.

FIG. 8 is a flow diagram illustrating operations for a meta-game, according to some embodiments of the inventive subject matter. In FIG. 8, the flow 800 begins at block 802, where a meta-game module subscribes to receive events occurring on a computing device. The computing device can include a browser, wagering game API, wagering game modules, meta-game module, and messaging service (e.g., see FIG. 2). In some embodiments, components register with the messaging service to receive and publish event messages. For example, if a new wagering game becomes available during a gaming session, the new wagering game module can register with the messaging service to publish and receive events. Any of the components in the computing device can utilize the messaging service.

At block 804, the meta-game module receives one or more event messages arising from operations of the wagering game modules (e.g., game results), API (e.g., duration of game play, credit information), browser (e.g., player input), etc. At block 806, the meta-game module determines whether one or more events are relevant to progress of the meta-game. If the events are irrelevant, the flow loops back to block 804.

If the events are relevant, the flow continues at block 808, where the meta-game progresses based on the one or more events. At block 810, the meta-game module determines whether to present an award. For example, if the meta-game progressed to an award state (e.g., winning pay line in slots game), the meta-game module presents an award to the player. In some embodiments, presenting the award may include paying money to the player account or other operations for providing monetary value to the player. In some embodiments, the award may include unlocking content (e.g., game episodes, new games, etc.). The flow continues at block 814.

At block 814, the meta-game module determines whether the meta-game is over. If the meta-game is over the flow ends. Otherwise, the flow loops back to block 804.

### Wagering Game Networks

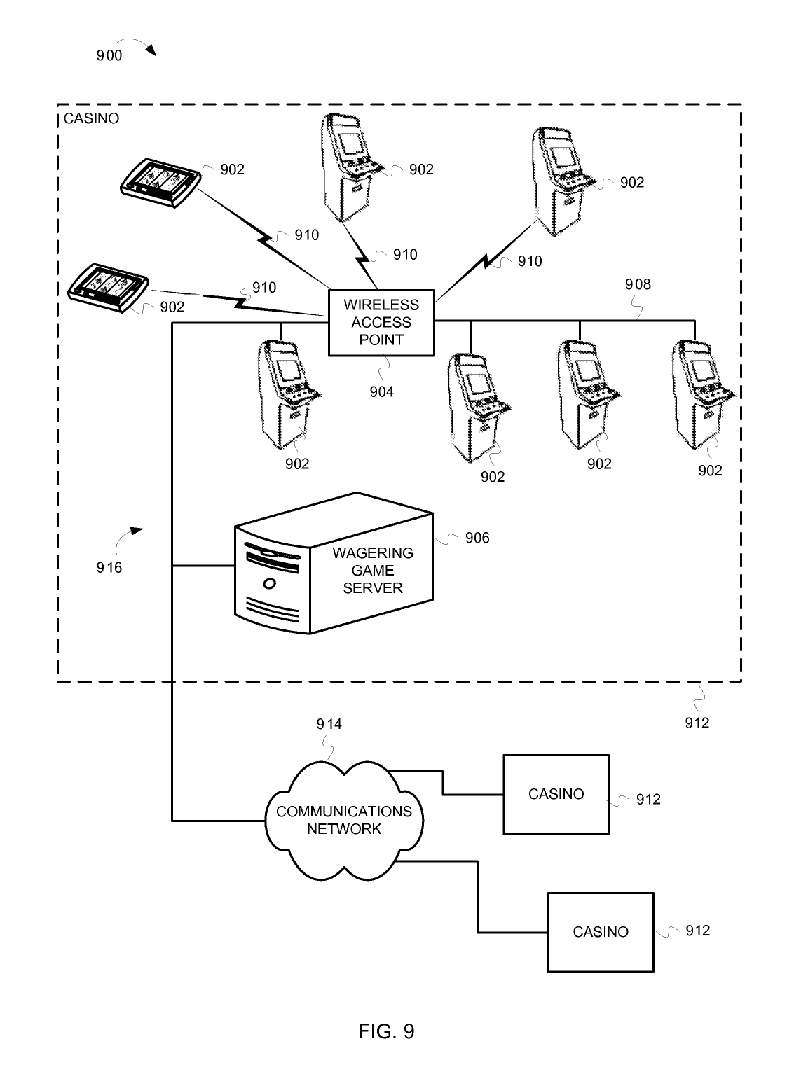

FIG. 9 is a block diagram illustrating a wagering game network 900, according to example embodiments of the invention. As shown in FIG. 9, the wagering game network 900 includes a plurality of casinos 912 connected to a communications network 914.

Each casino 912 includes a local area network 916, which includes an access point 904, a wagering game server 906, and wagering game machines 902. The access point 904 provides wireless communication links 910 and wired communication links 908. The wired and wireless communication links can employ any suitable connection technology, such as Bluetooth, 802.11, Ethernet, public switched telephone networks, SONET, etc. In some embodiments, the wagering game server 906 can serve wagering games and distribute content to devices located in other casinos 912 or at other locations on the communications network 914.

The wagering game machines 902 described herein can take any suitable form, such as floor standing models, handheld mobile units, bartop models, workstation-type console models, etc. Further, the wagering game machines 902 can be primarily dedicated for use in conducting wagering games, or can include non-dedicated devices, such as mobile phones, personal digital assistants, personal computers, etc. In one embodiment, the wagering game network 900 can include other network devices, such as accounting servers, wide area progressive servers, player tracking servers, and other devices suitable for use in connection with embodiments of the invention.

In some embodiments, wagering game machines 902 and wagering game servers 906 work together such that a wagering game machine 902 can be operated as a thin, thick, or intermediate client. For example, one or more elements of game play may be controlled by the wagering game machine 902 (client) or the wagering game server 906 (server). Game play elements can include executable game code, lookup tables, configuration files, game outcome, audio or visual representations of the game, game assets or the like. In a thin-client example, the wagering game server 906 can perform functions such as determining game outcome or managing assets, while the wagering game machine 902 can present a graphical representation of such outcome or asset modification to the player (e.g., player). In some embodiments, the wagering game machine 902 includes a browser and API, as described above. In such embodiments, the wagering game machines 902 can provide the functionality described herein (e.g., perform operations and communications similar to those described above).

In some embodiments, either the wagering game machines 902 (client) or the wagering game server 906 can provide functionality that is not directly related to game play. For example, account transactions and account rules may be managed centrally (e.g., by the wagering game server 906) or locally (e.g., by the wagering game machine 902). Other functionality not directly related to game play may include power management, presentation of advertising, software or firmware updates, system quality or security checks, etc.

Any of the wagering game network components (e.g., the wagering game machines 902) can include hardware and machine-readable media including instructions for performing the operations described herein.

### General

While the inventive subject matter is susceptible of embodiment in many different forms, there is shown in the drawings and herein described in detail preferred embodiments with the understanding that the present disclosure is to be considered as an exemplification of the principles of the inventive subject matter and is not intended to limit the broad aspect of the inventive subject matter to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A method for presenting wagering games in a browser on a mobile device, the method comprising:
detecting, in an application programming interface (API) on the mobile device, a request to initiate a wagering game in the browser on the mobile device;
after detecting the request, receiving one or more API calls from a wagering game module residing on the mobile device, wherein the API calls request wagering-game-specific services to facilitate progress of the wagering game;
transmitting, by the API to the browser, information needed by the wagering game module to present the wagering game in the browser.

2. The method of claim 1, wherein the request to initiate the wagering game originates from the browser.

3. The method of claim 1, wherein the wagering-game-specific service include services include services for providing information about credits available for betting on the wagering game.

4. The method of claim 1, wherein the wagering game module is a plug-in of the browser, and wherein the method further comprises:
determining, by the wagering game module, a result for the wagering game; and
presenting, in the browser by the wagering game module, graphics and sound representing results of the wagering game.

5. The method of claim 1, wherein the wagering-game-related services include services to save results of the wagering game in a remote device.

6. The method of claim 1, wherein the API and wagering game module were created by different manufacturers.

7. The method of claim 1, wherein the wagering-game-specific services cause presentation, in the browser, of celebration animations after the wagering game is complete.

8. A computer-readable storage medium including instructions which, when executed by one or more processors, cause the one or more processors to perform operations for presenting a meta-game in a browser, the method comprising:
subscribing a meta-game module to receive messages indicating events resulting from operations of a wagering game application programming interface (API) and a plurality of wagering game modules, wherein the wagering game API and the wagering game modules cause presentation of a plurality of wagering games in the browser;
receiving, in the meta-game module, at least one of the messages indicating an event in one of the wagering games;
determining that the event causes progress of a game element of the meta-game;
presenting, in the browser via the meta-game module, the progress of the game element of the meta-game.

9. The computer-readable storage medium of claim 8, wherein the operations further comprise:
receiving, in the meta-game module, another of the messages indicating another event in another of the wagering games;
determining that the other event triggers an award including granting access to a new wagering game;
granting a player account access to the new wagering game.

10. The computer-readable storage medium of claim 8, wherein the presenting, in the browser via the meta-game module, the progress of the game element of the meta-game further includes:
calling, by the meta-game module, the wagering game API to cause presentation, in the browser, of graphics representing the progress of the game element.

11. The computer-readable storage medium of claim 8 further comprising:
registering, by a messaging service, the meta-game module to be a subscriber that receives messages indicating events resulting from operations of the wagering game application programming interface (API) and the plurality of wagering game modules;
registering, by the messaging service, the wagering game API and the plurality of wagering game modules to be publishers providing the messages indicating events resulting from operations of the wagering game application programming interface (API) and the plurality of wagering game modules.

12. The computer-readable storage medium of claim 8 further comprising:
granting, by the meta-game module, access to wagering game content based on the progress of the game element of the meta-game.

13. The computer-readable storage medium of claim 8, wherein the operations further comprise:
receiving, in the meta-game module, another of the messages indicating another event in another of the wagering games;
determining, by the met-game module, that the other event triggers presentation of celebratory audio and video content in the browser;
calling the wagering game API to cause presentation of the celebratory audio and video in the browser;

14. A method for presenting a plurality of wagering games from a plurality of wagering game makers in a browser with a wagering game application programming interface (API), the method comprising:
determining, by a control module, that a first of a plurality of wagering game modules operating in the browser has completed a first wagering game;
presenting, in the browser by the control module, information about the first wagering game using content for creating a common gaming experience for the plurality of wagering game modules;
determining, by the control module, that a second of the plurality of wagering game modules operating in the browser has completed a second wagering game; and
presenting, in the browser by the control module, information about the second wagering game using content for creating a common gaming experience for the plurality of wagering game modules.

15. The method of claim 14, wherein the content for creating a common gaming experience for the plurality of wagering game modules includes graphics and audio content.

16. The method of claim 14, wherein the information about the first wagering game includes one or more of credits won, credits lost, time playing the first wagering game, and credits available for betting.

17. The method of claim 14, wherein the presenting, in the browser by the control module, information about the second wagering game using content for creating a common gaming experience for the plurality of wagering game modules includes calling the wagering game API to present the information in the browser.

18. The method of claim 14, wherein the content for creating a common gaming experience for the plurality of wagering game modules includes a player avatar.

19. The method of claim 14, wherein the content for creating a common gaming experience for the plurality of wagering game modules includes branding for a website from which the API and wagering game modules were downloaded.

20. The method of claim 14 further comprising:
unlocking, by the control module, new wagering games offered by the plurality of wagering game modules.
